(19) United States
(12) Patent Application Publication
(10) Pub. No.: US 2007/0013855 A1
(43) Pub. Date: Jan. 18, 2007

(54) Liquid crystal display device

(76) Inventors: Masanori Ando, Himeji-shi (JP); Masanobu Nonaka, Ibo-gun (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/478,624

(22) Filed: Jul. 3, 2006

(30) Foreign Application Priority Data
Jul. 12, 2005 (JP) 2005-203186

(51) Int. Cl. G02F 1/1345

(52) U.S. Cl. 349/149

(57) ABSTRACT

An array substrate includes a power supply line for supplying a predetermined potential to a counter-electrode, a power supply pad which is disposed on an insulation film that covers the power supply line, and a connection part which connects the power supply line and the power supply pad via a contact hole that is formed in the insulation film. The connection part is disposed inside an outer edge of a seal region.

### CROSS-REFERENCE TO RELATED APPLICATIONS

This application is based upon and claims the benefit of priority from prior Japanese Patent Application No. 2005-203186, filed Jul. 12, 2005, the entire contents of which are incorporated herein by reference.

### BACKGROUND OF THE INVENTION

1. Field of the Invention

The present invention relates generally to a liquid crystal display device, and more particularly to a structure for supplying power from a power supply line, which is disposed on one of two substrates, to an electrode which is disposed on the other substrate.

2. Description of the Related Art

A liquid crystal display device, which is a typical example of a flat-screen display device, includes a liquid crystal display panel that is constructed such that a liquid crystal layer is held between an array substrate and a counter-substrate which are attached to each other via a seal member. The liquid crystal display panel includes an active area that is composed of matrix-arrayed pixels. The active area includes a plurality of scan lines which extend in a row direction of the pixels, a plurality of signal lines which extend in a column direction of the pixels, switching elements which are disposed near intersections of the scan lines and signal lines, and pixel electrodes which are connected to the associated switching elements.

There have been proposed various power supply structures for supplying potential from the array substrate side to a counter-electrode which is disposed on the counter-substrate. A patent document (Jpn. Pat. Appln. KOKAI Publication No. 2001-264779), for instance, proposes a power supply structure wherein two electrically conductive layers, which are opposed via an insulation layer, are connected via a contact hole that is formed in the insulation layer, and an electrically conductive member is disposed between the electrically conductive layer disposed on the insulation layer and a power supply section of the array substrate.

In the above-described patent document, the two electrically conductive layers are connected on an outside of a region where a seal member is disposed. In this case, the connection part between the two conductive layers easily comes in contact with outside air. In particular, in a case where the two conductive layers are formed of different metallic materials, electrochemical corrosion will easily occur on the connection part due to contact with outside air. Such corrosion may cause an increase in resistance of the power supply structure, and may also cause line breakage. Moreover, if corrosion progresses to wiring within the active area, degradation in display quality may occur.

### BRIEF SUMMARY OF THE INVENTION

The present invention has been made in consideration of the above-described problem, and the object of the invention is to provide a liquid crystal display device which is capable of suppressing corrosion and has high reliability.

According to an aspect of the present invention, there is provided a liquid crystal display apparatus which is configured such that a liquid crystal layer is held between a pair of substrates which are attached to each other via a seal member, one of the substrates comprising: a power supply line for supplying a predetermined potential to the other substrate; a power supply pad which is disposed on an insulation film that covers the power supply line; and a connection part which connects the power supply line and the power supply pad via a contact hole that is formed in the insulation film, and which is disposed inside an outer edge of a seal region where the seal member is disposed.

This invention can provide a liquid crystal display device which is capable of suppressing corrosion at a connection part and has high reliability.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display panel of a liquid crystal display apparatus according to an embodiment of the present invention;

FIG. 2 is a cross-sectional view that schematically shows the structure of a pixel in the liquid crystal display panel shown in FIG. 1;

FIG. 3 is a plan view for describing a power supply structure which is applicable to the liquid crystal display panel shown in FIG. 1;

FIG. 4 is a cross-sectional view, taken along line A-A in FIG. 3, which schematically shows the power supply structure; and

FIG. 5 is a plan view for describing another power supply structure which is applicable to the liquid crystal display panel shown in FIG. 1.

### DETAILED DESCRIPTION OF THE INVENTION

A display device according to an embodiment of the present invention, in particular, a liquid crystal display device, will now be described with reference to the accompanying drawings.

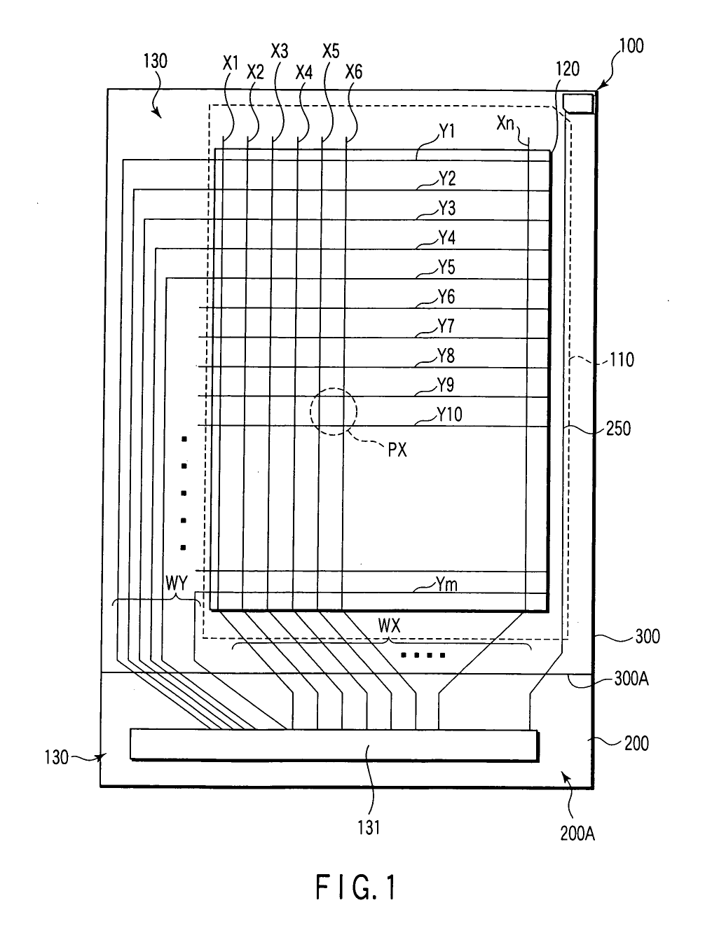

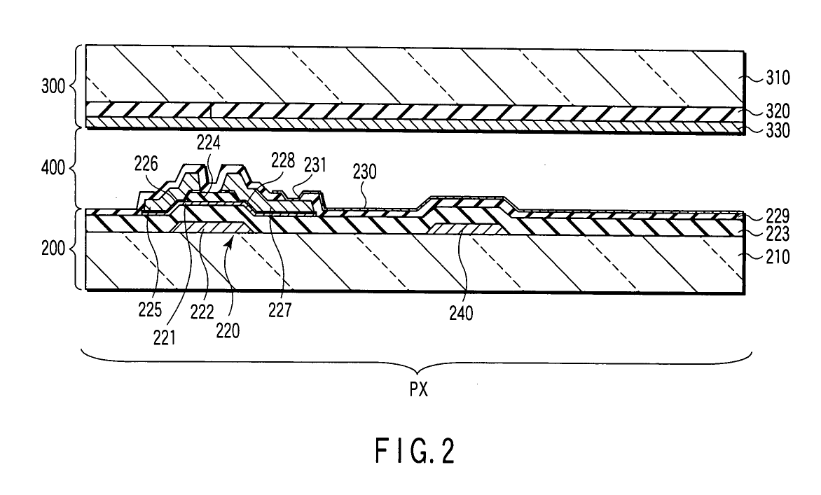

As is shown in FIG. 1 and FIG. 2, a liquid crystal display device includes a liquid crystal display panel 100. Specifically, the liquid crystal display panel 100 comprises a pair of substrates, that is, an array substrate 200 and a counter-substrate 300, and a liquid crystal layer 400 that is held between the array substrate 200 and counter-substrate 300. The array substrate 200 and counter-substrate 300 are attached to each other by a seal member 110, and a predetermined gap for holding the liquid crystal layer 400 is provided between the array substrate 200 and counter-substrate 300. The liquid crystal display panel 100 includes an active area 120, which displays an image, within an inner area surrounded by the seal member 110. The active area 120 is composed of a plurality of pixels PX that are arranged in a matrix.

The array substrate 200 is formed by using a light-transmissive insulating substrate 210 such as a glass substrate. In the active area 120, the array substrate 200 includes, on one major surface (inner surface) of the insulating substrate 210, a plurality of scan lines Y (1, 2, 3, . . . , m) that extend in a row direction of the pixels PX, a plurality of signal lines X (1, 2, 3, . . . , n) that extend in a column direction of the pixels PX, switching elements 220 that are arranged near intersections between scan lines Y and signal lines X in the respective pixels PX, and pixel electrodes 230 that are connected to the switching elements 220 of the pixels PX.

The switching element 220 is formed of a thin-film transistor (TFT) which includes a semiconductor layer 221 such as a polysilicon film or an amorphous silicon film. A gate electrode 222 of the switching element 220 is provided on the insulating substrate 210 and is covered with a gate insulation film 223. The gate electrode 222 is formed of, e.g. molybdenum-tungsten (MoW), and is connected to the associated scan line Y (in this example, the gate electrode 222 is formed integral with the scan line Y). The gate insulation film 223 is formed of, e.g. a silicon oxide film (SiO) or a silicon nitride film (SiN). The semiconductor layer 221 is disposed on the gate insulation film 223, and a channel region thereof is covered with a protection film 224.

A source electrode 225 of the switching element 220 is put in contact with the semiconductor layer 221 via a low-resistance film 226. The source electrode 225 is a stacked element that is formed of, e.g. molybdenum (Mo)/aluminum (Al)/molybdenum (Mo), and is connected to the associated signal line X (in this example, the source electrode 225 is formed integral with the signal line X). A drain electrode 227 of the switching element 220 is put in contact with the semiconductor layer 221 via a low-resistance film 228. The drain electrode 227 is a stacked element that is formed of, e.g. molybdenum (Mo)/aluminum (Al)/molybdenum (Mo). The source electrode 225 and drain electrode 227 are covered with an interlayer insulation film 229. The interlayer insulation film 229 is formed of, e.g. a silicon nitride film (SiN).

The pixel electrode 230 is connected to the drain electrode 227 via a contact hole 231 that is formed in the interlayer insulation film 229. In a transmissive liquid crystal display panel which displays an image by selectively passing backlight, the pixel electrode 230 is formed of a light-transmissive electrically conductive material such as indium tin oxide (ITO) or indium zinc oxide (IZO). In a reflective liquid crystal display panel which displays an image by selectively reflecting ambient light, the pixel electrode 230 is formed of a light-reflective electrically conductive material such as aluminum.

The array substrate 200 includes a storage capacitance line 240 that is disposed on the insulating substrate 210. The storage capacitance line 240, like the gate electrode 222, is formed of, e.g. molybdenum-tungsten (MoW).

The counter-substrate 300 is formed by using a light-transmissive insulating substrate 310 such as a glass substrate. In the active area 120, the counter-substrate 300 includes a color filter 320 on one major surface (inner surface) of the insulating substrate 310. Specifically, a color display type liquid crystal display device includes a plurality of kinds of pixels, for instance, a red pixel that displays red (R), a green pixel that displays green (G), and a blue pixel that displays blue (B). The counter-substrate 300 includes, on the insulating substrate 310, a red color filter that passes light with a principal wavelength of red in association with the red pixel, a green color filter that passes light with a principal wavelength of green in association with the green pixel, and a blue color filter that passes light with a principal wavelength of blue in association with the blue pixel.

In addition, in the active area 120, the counter-substrate 300 includes a counter-electrode 330 which is common to the plural pixels PX. The counter-electrode 330 is disposed to be opposed to the plural pixel electrodes 230. The counter-electrode 330 is formed of a light-transmissive electrically conductive material such as ITO or IZO.

The inner surfaces of the array substrate 200 and counter-substrate 300 are covered with alignment films for controlling alignment of liquid crystal molecules that are included in the liquid crystal layer 400. In addition, the outer surfaces of the array substrate 200 and counter-substrate 300 are provided with polarizer plates, whose directions of polarization are set in accordance with the characteristics of the liquid crystal layer 400, and retardation plates.

The liquid crystal display panel 100 includes a connection section 131 which is disposed on an outer peripheral part 130 that is located outside the active area 120. The connection section 131 is connectable to a driving IC chip or a flexible wiring board, which functions as a signal supply source. In the example shown in FIG. 1, the connection section 131 is disposed on an extension part 200A of the array substrate 200, which extends to the outside of an end portion 300A of the counter-substrate 300.

The scan lines Y (1, 2, 3, . . . , m), which are disposed in the active area 120, are connected to the connection section 131 via connection wiring lines WY which are disposed on the outer peripheral part 130. The signal lines X (1, 2, 3, . . . , n) are connected to the connection section 131 via connection wiring lines WX which are disposed on the outer peripheral part 130.

Next, a power supply structure for supplying a potential from the array substrate side to the counter-electrode is described.

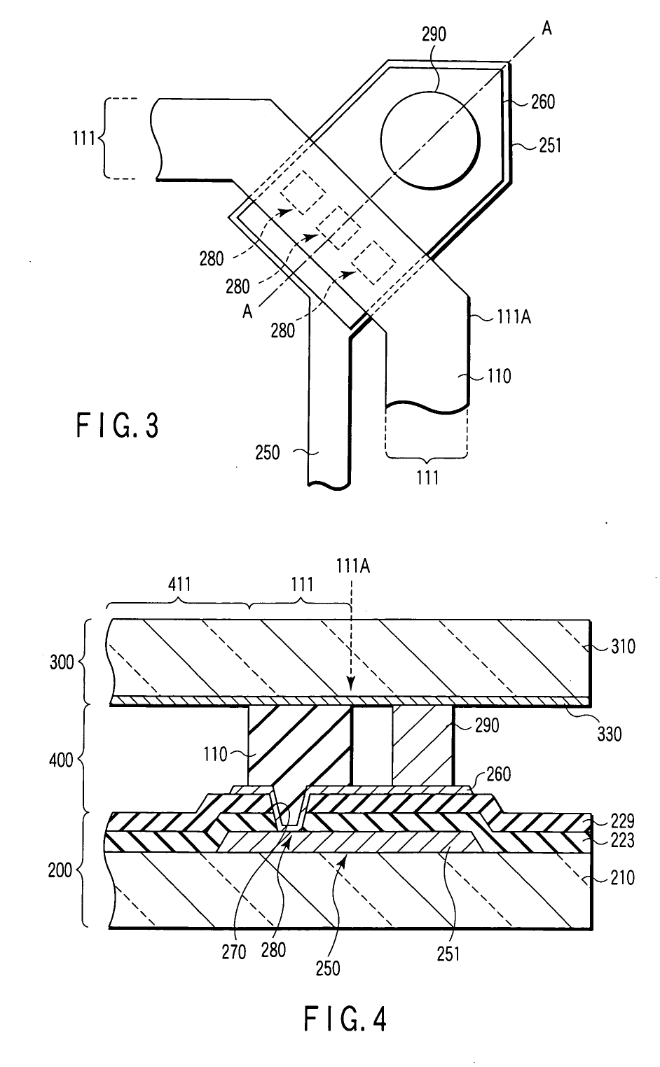

As is shown in FIG. 1, FIG. 3 and FIG. 4, the array substrate 200 includes a power supply line 250 for supplying a predetermined potential to the counter-electrode 330; a power supply pad 260 which is disposed on the insulation films covering the power supply line 250, that is, the gate insulation film 223 and interlayer insulation film 229; and a connection part 280 for connecting the power supply line 250 and power supply pad 260 via a contact hole 270 that is formed in the insulation films 223 and 229.

The connection part 280 mainly corresponds to a connection part between the power supply line 250 and power supply pad 260, and it also includes a part corresponding to the contact hole 270. The connection part 280 is disposed inside an outer edge 111A of a seal region 111. Specifically, the entirety of the connection part 280 is disposed within the seal region 111 and a liquid crystal region 411 that is surrounded by the seal region 111 and filled with the liquid crystal layer 400. The connection part 280 does not directly contact outside air on the outside of the seal region 111.

Thus, even if the power supply line 250 and power supply pad 260 are formed of different metallic materials, corrosion at the connection part 280 can be suppressed. Therefore, it is possible to prevent an increase in resistance of the power supply structure, line breakage, and degradation in display quality due to the progress of corrosion, and to provide a highly reliable liquid crystal display device.

This power supply structure will be described in greater detail.

The power supply line 250 is disposed on the outer peripheral part 130. In the example shown in FIG. 1, the power supply line 250 extends on the inside of the seal region 111 where the seal member 110 is mainly disposed. One end portion of the power supply line 250 is connected to the connection section 131. The power supply line 250 has an electrode part 251. At least a part of the electrode part 251 is disposed within the seal region 111. The electrode part 251 corresponds to, e.g. an intermediate part of the power supply line 250, the other end portion of the power supply line 250, or a branch line of the power supply line 250.

A part of the power supply pad 260 is disposed within the seal region 111, and constitutes the connection part 280. In addition, a part of the power supply pad 260 extends on the outside of the seal region 111. In other words, the electrode part 251 and power supply pad 260 partly overlap with each other within the seal region 111 via the insulation films 223 and 229. The connection part 280 is disposed in that part of the overlapping portion between the electrode part 251 and power supply pad 260, which is located inside the outer edge 111A of the seal region 111.

On the other hand, the counter-electrode 330, which is disposed on the counter-substrate 300, extends not only to the liquid crystal region 411 but also to the outside of the seal region 111. The power supply pad 260 and counter-electrode 330 are electrically connected via a conductive member 290. In other words, a potential of the power supply line 250 is supplied via the electrode part 251 and power supply pad 260, which are connected at the connection part 280, and is then supplied to the counter-electrode 330 via the conductive member 290.

The power supply line 250 including the electrode part 251 is formed, for example, of the same material (e.g. molybdenum-tungsten (MoW)) as the storage capacitance line 240 that is disposed on the array substrate 200. The power supply pad 260 is formed, for example, of the same material (e.g. ITO) as the pixel electrode 230 that is disposed on the array substrate 200.

The connection part 280 for connecting the electrode part 251 and power supply pad 260, which are formed of different kinds of metallic materials, is not exposed to the outside of the outer edge 111A of the seal region 111. Thus, corrosion at the connection part 280 can be suppressed. In particular, in the example shown in FIG. 3 and FIG. 4, the entirety of the connection part 280 is disposed within the seal region 111 (i.e. the seal member 110 is filled in the part corresponding to the contact hole 270). Thus, the connection part 280 contacts neither outside air nor an electrolyte that causes corrosion. Therefore, the anti-corrosion effect is further improved.

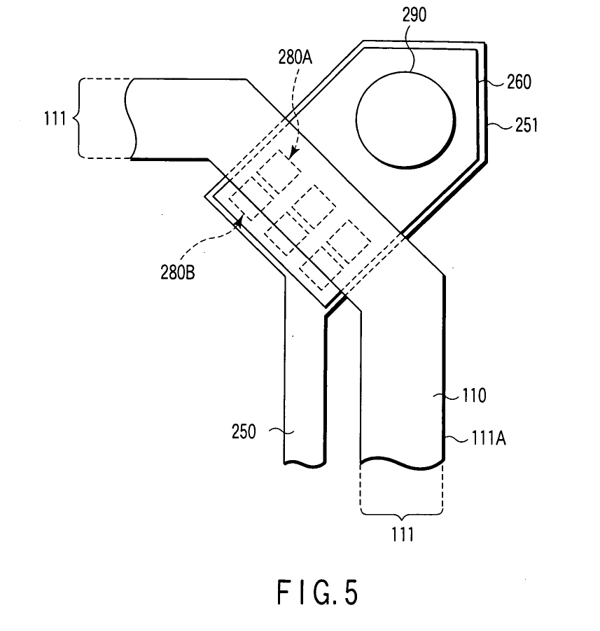

As is shown in FIG. 5, the connection part, which connects the power supply line 250 (electrode part 251) and the power supply pad 260, may include a first connection part 280A which is entirely disposed within the seal region 111, and a second connection part 280B which is partly disposed within the seal region 111. The second connection part 280B contacts the liquid crystal layer on the inside of the seal region 111, but does not contact outside air. In short, it should suffice if the entirety of the connection part is disposed inside the outer edge 111A of the seal region 111. No problem arises even if the connection part is partly disposed inside the seal region 111. Even with the configuration shown in FIG. 5, like the example of FIG. 3, corrosion at the connection part can be suppressed.

The present invention is not limited directly to the above-described embodiment. In practice, the structural elements can be modified without departing from the spirit of the invention. Various inventions can be made by properly combining the structural elements disclosed in the embodiment. For example, some structural elements may be omitted from all the structural elements disclosed in the embodiment. Furthermore, structural elements in different embodiments may properly be combined.

What is claimed is:

1. A liquid crystal display apparatus which is configured such that a liquid crystal layer is held between a pair of substrates which are attached to each other via a seal member, one of the substrates comprising:
a power supply line for supplying a predetermined potential to the other substrate;
a power supply pad which is disposed on an insulation film that covers the power supply line; and
a connection part which connects the power supply line and the power supply pad via a contact hole that is formed in the insulation film, and which is disposed inside an outer edge of a seal region where the seal member is disposed.

2. The liquid crystal display apparatus according to claim 1, wherein the connection part is disposed within the seal region.

3. The liquid crystal display apparatus according to claim 1, wherein the power supply line includes an electrode part which extends on an inside of the seal region and overlaps with the power supply pad within the seal region via the insulation film.

4. The liquid crystal display apparatus according to claim 1, wherein the power supply pad extends on an outside of the seal region and electrically connects the pair of substrates via a conductive member.

5. The liquid crystal display apparatus according to claim 1, wherein the power supply line is formed of the same material as a storage capacitance line which is disposed on said one of the substrates.

6. The liquid crystal display apparatus according to claim 1, wherein the power supply pad is formed of the same material as a pixel electrode which is disposed on said one of the substrates.

7. A liquid crystal display device comprising:
an array substrate including a plurality of matrix-arrayed pixel electrodes, a power supply line including an electrode part for supplying a predetermined potential, a power supply pad which is disposed over the electrode part via an insulation film covering the power supply line, and a connection part which connects the electrode part and the power supply pad via a contact hole that is formed in the insulation film;
a counter-substrate including a counter-electrode which is disposed to be opposed to the plurality of pixel electrodes;
a seal member by which the array substrate and the counter-substrate are attached to each other with a predetermined gap being provided therebetween;
a liquid crystal layer which is held in the gap between the array substrate and the counter-substrate; and
a conductive member which electrically connects the power supply pad and the counter-electrode on an outside of a seal region where the seal member is disposed,
wherein the connection part is disposed on an inside of an outer edge of the seal region.
